(19) United States
(12) Patent Application Publication
(10) Pub. No.: US 2001/0055376 A1
(43) Pub. Date: Dec. 27, 2001

(54) No caller ID call block

(76) Inventor: Gregg Karas, W. Milford, NJ (US)

Correspondence Address: Rodger Flagg, Patent Agent, PMB 270, 2101 Crystal Plaza Arc., Arlington, VA, 22202, US

(21) Appl. No.: 09/858,498

(22) Filed: May 17, 2001

Related U.S. Application Data
(60) Provisional application No. 60/214,553, filed on Jun. 27, 2000.

(51) Int. Cl. H04M 11/00; H04M 1/60; H04M 13/00; H04M 3/00

(52) U.S. Cl. 379/142.02; 379/93.17; 379/142.04; 379/168; 379/184; 379/194

(57) ABSTRACT

A device enables a user to block telephone numbers designated by a caller ID device as “Unavailable”, “Out of Area”, and “Private” numbers. And, specified numbers can be provided in a list and blocked. A user can optionally select actions for the “No Caller ID Call Block” situation. In a first setting the telephone line ring can be suppressed, caller ID data read, and a determination made whether to pass or block the call. In this first case, the block will be performed by the telephone line going off-hook momentarily and back on-hook, such that the call is answered and subsequently disconnected. In a second setting, the block will be performed by the telephone line going off-hook momentarily and back on-hook, such that the call is answered and subsequently disconnected. In a third setting, the telephone line ring will be suppressed, and the block will be performed by suppressing the ring of the telephone for the entire duration of the call attempt. In a fourth setting the telephone line ring can be suppressed, and the block will be performed by answering the telephone call automatically and supplying a message to the caller.

### Parts List

10—Telco

12—telephone line

14—telephone

20—customer premise equipment

22—input protection circuit

24—demodulator input circuit

28—ring detector

30—automatic power up circuit

32—data line (CID data)

34—RDO line (ring detector output)

36—CDO line (carrier detector output)

40—crystal network

50—micro controller and memory device

60—off-hook circuit

70—ring suppression circuit

80—recorded message circuit

82—display

84—message

92—switch

94—housing

96—telephone jack

110—ring

112—tip

### FIELD OF THE INVENTION

The present invention relates to devices for identifying callers using a service such as “caller ID” and for selectively blocking calls. More particularly, the invention relates to a device for selectively blocking calls from telephone numbers wherein no caller identification is provided.

### BACKGROUND OF THE INVENTION

There are known types of caller ID (caller identification) services. For such services, the prior shows that it is a problem to block unwanted calls. Those making such unwanted calls may try to circumvent the caller ID service by listing their number as a “private” number (i.e., so that their telephone number is not provided to the recipient of the call, as permitted by at least some called ID services) or by routing their call through an “out-of-area” telephone system.

U.S. Pat. No. 5,781,613 to Knuth teaches a telephone answering system for screening incoming telephone calls with blocked calling party identification information. This device provides for a plurality of ways of responding to those callers who purposely block their own CPID (calling party identification).

U.S. Pat. No. 5,768,365 to McKendry teaches a circuit for sensing telephone line conditions, and includes a call manager device. This device has the ability to screen calls and can be programmed to suit the needs of the user.

U.S. Pat. No. 5,497,414 to Bartholomew teaches a telephone system capable of processing designated caller ID private calls, including call processing records (CPR) and status of certain numbers, and automated disconnect for specified incoming callers.

U.S. Pat. No. 5,937,052 to Cook-Hellberg teaches an anonymous call rejection override, which includes an advance subscriber feature including ACR (automatic call rejection) which denies a requested call which originates from those who refuse to disclose their own CPID, and also including an emergency override.

U.S. Pat. No. 5,526,406 to Luneau teaches a means of announcing a telephone call and rejecting the call.

U.S. Pat. No.

5,881,134 to Foster teaches an “intelligent” call processing system for a home phone system, having “smart ringing” and permitting disconnection of calls not on a list.

U.S. Pat. No. 5,872,840 to Wu teaches a system for rejecting certain telephone calls and includes a DND (do not disturb) feature that blocks all or selected calls.

U.S. Pat. No. 5,467,388 to Redd, Jr., teaches an intelligent call blocking system, for example for specified numbers, numbers without a PIN, and all numbers for a specified time period.

U.S. Pat. No. 5,278,894 to Shaw teaches a call screening method based on ICLID (incoming caller line identification), and includes selective rejection of calls, and acceptance of calls only from a specified list.

U.S. Pat. No. 5,033,076 to Jones teaches a class of service for a telephone system which includes anonymous call rejection (ACR) so that only those calls will be completed which allow their telephone numbers to be displayed.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a selection of ways of blocking unwanted telephone calls.

As mentioned herein, there are known types of caller ID (caller identification) services. For such services, the prior shows that it is a problem to block unwanted calls. Those making such unwanted calls may try to circumvent the caller ID service by listing their number as a “private” number (i.e., so that their telephone number is not provided to the recipient of the call, as permitted by at least some called ID services) or by routing their call through an “out-of-area” telephone system. It is a further problem in the art to provide the user with a selection of ways of selecting which calls to pass through and which to block, as well as the manner in which the calls are blocked.

The device of the present invention operates as an enhancement to existing caller ID devices and systems. The telephone company entity in the region (hereinafter referred to in accordance with convention as “Telco”) usually offers two services in this regard, caller identification (caller ID) and call blocking.

In accordance with the present invention, the user can block (among others) a list of numbers designated by the caller ID device as “Unavailable”, “Out of Area” , and “Private” numbers. Additionally, specified numbers can be provided in a list and blocked.

Further, the user can optionally select actions for the “No Caller ID Call Block” situation. For example, in a first setting the telephone line ring can be suppressed, caller ID data read, and a determination made whether to pass or block the call. In this first case, the block will be performed by the telephone line going off-hook momentarily and back on-hook, such that the call is answered and subsequently disconnected.

In a second setting, the telephone line will ring until such time as the caller ID data read, and a determination made whether to pass or block the call. In this second case, the block will be performed by the telephone line going off-hook momentarily and back on-hook, such that the call is answered and subsequently disconnected.

In a third setting, the telephone line ring will be suppressed, caller ID data read, and a determination made whether to pass or block the call. In this third case, the block will be performed by suppressing the ring of the telephone for the entire duration of the call attempt.

In a fourth setting the telephone line ring can be suppressed, caller ID data read, and a determination made whether to pass or block the call. In this fourth case, the block will be performed by answering the telephone call automatically and supplying a message to the caller. The message supplied can, for example, simply state “This person does not accept calls from parties who do not display their Caller ID information.” Then, the telephone goes off-hook and the call is thereby disconnected.

Other objects and advantages of the present invention will be more readily apparent from the following detailed description when read in conjunction with the accompanying drawings.

### BRIEF DESCRIPTION OF THE DRAWINGS

FIG. 1 is a schematic view of a device according to the present invention.

FIG. 2 is a perspective view of the housing containing system circuitry and components.

### DETAILED DESCRIPTION OF THE INVENTION

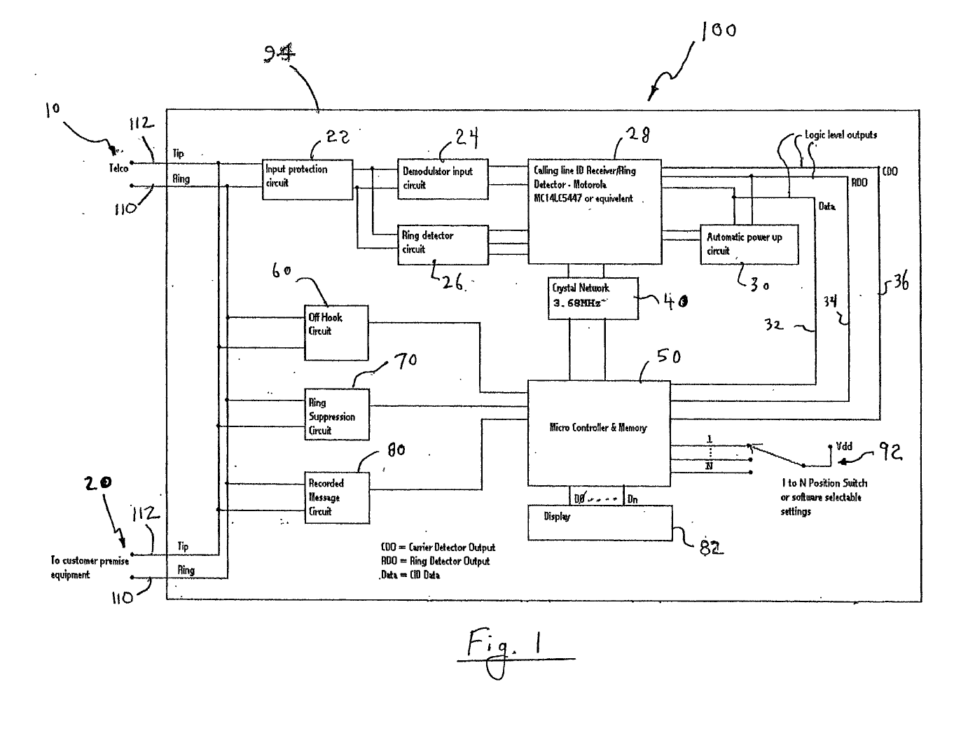

FIG. 1 shows a schematic view of a device according to the present invention, wherein a “No Caller ID Call Block” system 100 is provided. The system 100 provides a selection of ways of blocking unwanted telephone calls, as discussed hereunder.

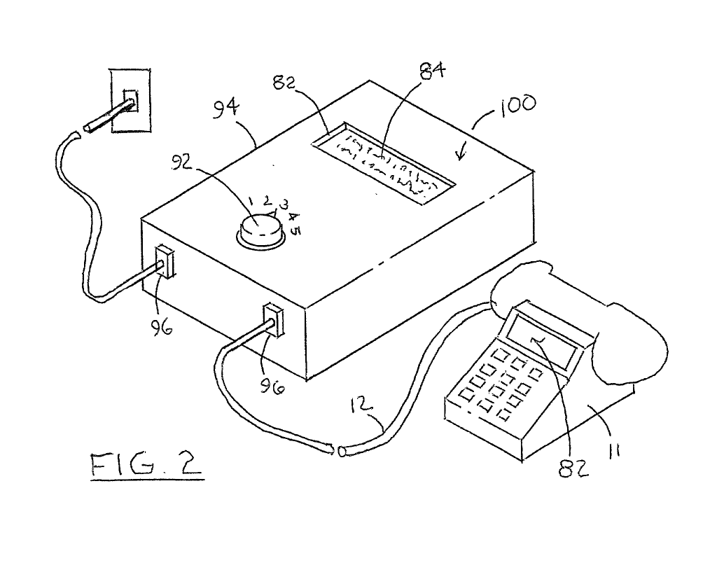

FIG. 2 is a perspective view of the housing 94 containing the system 100 circuitry and components.

There are known types of caller ID (caller identification) services. For such services, the prior art shows that it is a problem to block unwanted calls. Those making such unwanted calls may try to circumvent the caller ID service by listing their number as a “private” number (i.e., so that their telephone number is not provided to the recipient of the call, as permitted by at least some called ID services) or by routing their call through an “out-of-area” telephone system. It is a further problem in the art to provide the user with a selection of ways of selecting which calls to pass through and which to block, as well as the manner in which the calls are blocked.

The system 100 of the present invention operates as an enhancement to existing caller ID devices and systems. The telephone company entity in the region (hereinafter referred to in accordance with convention as “Telco” ) usually offers two services in this regard, caller identification (caller ID) and call blocking.

In accordance with the system 100, the user can block (among others) a list of numbers designated by the caller ID device as “Unavailable”, “Out of Area” , and “Private” numbers. Additionally, specified numbers can be provided in a list and blocked. Some telephone companies currently provide a means for blocking private and specific telephone numbers, but they do not work on unavailable and out of area numbers. This patent application includes a means of blocking “Private” telephone numbers and “specific” telephone numbers, as well as “Out of Area” telephone numbers, and “Unavailable” telephone numbers. Further, the user can optionally select actions for the “No Caller ID Call Block” situation.

As shown in FIG. 1, the system 100 is connected by respective pairs of tip 112 and ring 110 lines to the Telco 10, and to the customer premise equipment 20. These lines 110, 112 are also connected directly to an input protection circuit 22, an off-hook circuit 60, a ring suppression circuit 70, and a recorded message circuit 80.

The input protection circuit 22 is connected to both a demodulator input circuit 24 and a ring detector circuit 26, both of which are in turn connected to a “Calling line ID receiver/ring detector” 28(which is preferably a Motorola chip MC14LC5447 or equivalent). The ring detector 28 is in turn connected to a crystal network 40 (operating at 3.68 MHz, for example). The ring detector 28 is also connected to an automatic power-up circuit 30.

The ring detector 28 produces three logic level outputs “Data” , “RDO”, and “CDO” on lines 32, 34, and 36, respectively. These logic level outputs are supplied to a micro controller and memory device 50. The micro controller and memory device 50 also receives the outputs of the off hook circuit 60, the ring suppression circuit 70, and the recorded message circuit 80.

Additionally, the micro controller and memory device 50 is connected to a display 82 via a pair of lines Do. . . Dn. The display 82 may contain a message 84.

In FIG. 1, the abbreviations are explained as follows. The legend CDO refers to a carrier detector output. The legend RDO refers to a ring detector output. And, the legend Data refers to CID data.

The operation of the system 100 is explained as follows.

In a first setting the telephone line 12 ring can be suppressed, caller ID data 32 read, and a determination made whether to pass-the-call or block-the-call. In this first case, the block-the-call will be performed by the telephone line 12 going off-hook momentarily and back on-hook, such that the telephone call is answered and subsequently disconnected.

In a second setting, the telephone line 12 will ring until such time as the caller ID data 32 is read, and a determination made whether to pass-the-call or block-the-call. In this second case, the block-the-call will be performed by the telephone line 12 going off-hook momentarily and back on-hook, such that the call is answered and subsequently disconnected.

In a third setting, the telephone line 12 ring will be suppressed, caller ID data 32 read, and a determination made whether to pass-the-call or block-the-call. In this third case, the block-the-call will be performed by suppressing the ring of the telephone line 12 for the entire duration of the call attempt.

In a fourth setting the telephone line 12 ring can be suppressed, caller ID data 32 read, and a determination made whether to pass-the-call or block-the-call. In this fourth case, the block-the-call will be performed by answering the telephone line 12 call automatically and supplying a message 84 to the caller. The message 84 supplied can, for example, simply display 82 “This person does not accept calls from parties who do not display their Caller ID information.” Then, the telephone line 12 goes off-hook and the call is thereby disconnected.

Finally, in a fifth setting, only Caller ID data 32 is provided, and the system 100 provides no actions.

The first setting through fifth setting are controlled by a user selected switch 92 mounted on a housing 94 which contains the system 100 disclosed in FIG. 1. Alternately, the switch 92 may be controlled by software selectable settings.

Ring 110 and Tip 112 connections extend from Telco 10 to the input protection circuit 22 located within the housing 94. The ring 110 and tip 112 connections also extend to the off-hook circuit 60, the ring suppression circuit 70 and the recorded message circuit 80. The ring 110 and tip 112 lines also extend from the housing 94 to the customer premise equipment 20, as best shown in FIG. 1.

Telephone jacks 96 may be used to connect the telephone lines 12 to the ring 110 and tip 112 connections, as shown in FIG. 2.

The invention being thus described, it will be evident that the same may be varied in many ways. Such variations are not to be regarded as a departure from the spirit and scope of the invention and all such modifications are intended to be included within the scope of the claims.

I claim:

1. A no caller ID call block apparatus, which comprises:
a) a pair of tip and ring lines, which are connected between the telephone company and the customer premise equipment, and to a calling line ID receiver/ring detector;
b) the calling line ID receiver/ring detector is further connected to an input protection circuit, an off-hook circuit, a ring suppression circuit, and a recorded message circuit;
c) the input protection circuit is in turn connected to a demodulator input circuit and to a ring detector;
d) the demodulator input circuit and the ring detector are each connected to the calling line ID receiver/ring detector;
e) the ring detector is further connected to a crystal network, and to an automatic power-up circuit, and the ring detector produces at least three logic level outputs, the logic level outputs are in turn connected to a micro controller and a memory device;
f) the micro controller and the memory device also receive output from an off hook circuit, a ring suppression circuit and a recorded message circuit, the micro controller and the memory device are in turn connected by a pair of lines to a display device, which at times contains a message; and
g) the user can selectively block a list of specified numbers; the user can further selectively block numbers which do not provide a designated telephone number, and the user can elect to selectively pass or block the call after the caller ID is read.

2. The no caller ID call block apparatus of claim 1, wherein a call is blocked by suppressing the telephone line ring, going off-hook momentarily and back on hook, which serves to momentarily answer the call and to subsequently disconnect the call.

3. The no caller ID call block apparatus of claim 1, wherein the telephone line rings until the caller ID is read by a user, and a determination is then made by the user to selectively pass or block the call.

4. The no caller ID call block apparatus of claim 1, wherein the ring of the telephone is suppressed while the caller ID data is read, and a determination is made by the user to selectively answer or block the call, and the blocked calls continue to silently ring, until the caller terminates the telephone call.

5. The no caller ID call block apparatus of claim 1, wherein the telephone line ring is suppressed, the caller ID data is read, and a determination is made by the user to selectively answer or block the call, and the no caller ID call block apparatus will automatically answer the call and supply a pre-recorded message to the caller, and the telephone goes off-hook following the message.

6. The no caller ID call block apparatus of claim 1, wherein only caller ID data is provided to the user, and the telephone system provides no action in response to the telephone call.

7. The no caller ID block apparatus of claim 1, wherein a manually actuated user select switch is mounted on a housing containing the no caller ID block apparatus circuit, and said switch selectively controls the actuation of the no caller ID block apparatus.

8. The no caller ID block apparatus of claim 1, wherein the user selected switch is controlled by software selectable settings.

9. The no caller ID block apparatus of claim 1, wherein telephone jacks are used to connect the telephone lines to the ring and tip connections of the no caller ID block apparatus.

10. A no caller ID call block apparatus, which comprises:
a) a pair of tip and ring lines, which are connected between the telephone company and the customer premise equipment, and to a calling line ID receiver/ring detector;
b) the calling line ID receiver/ring detector is further connected to an input protection circuit, an off-hook circuit, a ring suppression circuit, and a recorded message circuit;
c) the input protection circuit is in turn connected to a demodulator input circuit and to a ring detector circuit;
d) the demodulator input circuit and the ring detector circuit are each connected to the calling line ID receiver/ring detector;
e) the ring detector is connected to a crystal network, and to an automatic power-up circuit, and the ring detector produces at least three logic level outputs, the logic level outputs connected to a micro controller and a memory device;
f) the micro controller and the memory device also receive output from an off hook circuit, a ring suppression circuit and a recorded message circuit, the micro controller and the memory device are in turn connected by a pair of lines to a display device, which at times contains a message;
g) a manually actuated user select switch is mounted on a housing containing the no caller ID block apparatus circuit, and said switch selectively controls the actuation of the no caller ID block apparatus; and
the user can selectively block a list of specified numbers; the user can further block numbers which do not provide a designated telephone number, and the user can elect to either pass or block the call after the caller ID is read.

11. The no caller ID call block apparatus of claim 10,wherein a call is blocked by suppressing the telephone line ring, going off-hook momentarily and back on hook, which serves to momentarily answer the call and to subsequently disconnect the call.

12. The no caller ID call block apparatus of claim 10, wherein the telephone line rings until the caller ID is read by a user, and a determination is then made by the user to selectively pass or block the call.

13. The no caller ID call block apparatus of claim 10, wherein the ring of the telephone is suppressed while the caller ID data is read, and a determination is made by the user to selectively answer or block the call, and the blocked calls continue to silently ring, until the caller terminates the telephone call.

14. The no caller ID call block apparatus of claim 10, wherein the telephone line ring is suppressed, the caller ID data is read, and a determination is made by the user to selectively answer or block the call, and blocked calls will automatically answer the call and supply a pre-recorded message to the caller, and wherein the telephone goes off-hook following the message.

15. The no caller ID call block apparatus of claim 10, wherein only caller ID data is provided to the user, and the telephone system provides no action in response to the telephone call.

16. The no caller ID block apparatus of claim 10, wherein the user selected switch is controlled by software selectable settings.

17. The no caller ID block apparatus of claim 10, wherein telephone jacks are used to connect the telephone lines to the ring and tip connections of the no-caller ID block apparatus.

18. A no caller ID call block apparatus, which comprises:
a) a pair of tip and ring lines, which are connected between the telephone company and the customer premise equipment, and to a calling line ID receiver/ring detector;
b) the calling line ID receiver/ring detector is further connected to an input protection circuit, an off-hook circuit, a ring suppression circuit, and a recorded message circuit;
c) the input protection circuit is in turn connected to a demodulator input circuit and to a ring detector circuit;
d) the demodulator input circuit and the ring detector circuit are each connected to the calling line ID receiver/ring detector;
e) the ring detector is connected to a crystal network, and to an automatic power-up circuit, and the ring detector produces at least three logic level outputs, the logic level outputs connected to a micro controller and a memory device;
f) the micro controller and the memory device also receive output from an off hook circuit, a ring suppression circuit and a recorded message circuit, the micro controller and the memory device are in turn connected by a pair of lines to a display device, which at times contains a message;
g) a user select switch is controlled by a plurality of software selectable settings;
and said switch selectively controls the actuation of the no caller ID block apparatus; and
the user can selectively block a list of specified numbers; the user can further block numbers which do not provide a designated telephone number, and the user can selectively pass or block the call after the caller ID is read.

19. The no caller ID block apparatus of claim 18, wherein a manually actuated user select switch is mounted on a housing containing the no caller ID block apparatus circuit, and said switch selectively controls the actuation of the no caller ID block apparatus.

20. The no caller ID block apparatus of claim 18, wherein telephone jacks are used to connect the telephone lines to the ring and tip connections of the no-caller ID block apparatus.
